(19) United States
(12) Patent Application Publication
(10) Pub. No.: US 2009/0056181 A1
(43) Pub. Date: Mar. 5, 2009

(54) Device for displaying lenticular images

(76) Inventors: David Meyer, Scranton, PA (US); Michael Waskovich, Dalton, PA (US)

Correspondence Address: ZALE Patent Law, 434 Lackawanna Ave., Suite 200, Scranton, PA, 18503-2053, US

(21) Appl. No.: 11/899,498

(22) Filed: Sep. 5, 2007

(51) Int. Cl. G02B 27/06; G03B 25/02

(52) U.S. Cl. 40/454; 359/619

(57) ABSTRACT

A lenticular image display device [10] for displaying a sequence of lenticular images comprises a receiver [20] for holding a lenticular picture [60] securely. The lenticular picture [60] has a series of images [55, 65, 75] designed to be viewed from various viewing angles over an optimum tilt arc ‘a’ and at an optimum rocking frequency ‘f’ which substantially matches the optimum tilt arc and viewing frequency of the lenticular image. The display [10] is designed to rock about a single axis of rotation. A weighting system [90] has an adjustable weight [91] positioned to allow rocking of the display device [10] at the optimum rocking frequency ‘f’, to allow the lenticular images [55, 65, 75] to be viewed clearly without blurring.

### BACKGROUND OF THE INVENTION

1. Field of the Invention

The present invention generally relates to a display device, and in particular, to a device for displaying a lenticular image. More specifically, the present invention relates to an improvement in displaying lenticular images.

2. Discussion of Related Art

A lenticular picture is one that allows a viewer to see one of several different images as one changes their viewing angle with respect to the picture. Lenticular pictures are already in use on a variety of items, such as: promotional buttons, magnets, coasters, collectibles, display posters, signs, menu boards, packaging on boxes, postcards and business cards. Lenticular technology is also in use on point-of-sale materials such as product labels and the like.

Those skilled in the art have found that when attempting to apply lenticular technology, the viewer, when viewing at a predetermined viewing angle, experiences distortion. This distortion might take any of a number of forms, e.g., from seeing portions of several different images simultaneously (i.e., banding), to experiencing blurring or bleeding of the image.

A problem that exists with these lenticular display devices is that the lenticular effect that allows only one view to be seen at a specific angle also has the same effect with illumination. A directed light source cannot illuminate all the views because the lenticules will direct the light to only those views that are at the viewing angle of the light source. If the light source under which the lenticular image is being viewed is at an angle different than the angle of the viewers eyes to the lenticular card, the image will appear very dark. Similarly, lenticular images are blurred when tilted in the wrong plane, at the wrong speed and/or tilted through the wrong arc.

Prior art practice in the maintenance of display devices is to mount large lenticular images in some type of frame which require the observer to physically change their position to see the different views. In this type of display the lenticules are typically oriented in the vertical direction so as the observer walks past the display, different views will be seen. Problems with this type of viewing are that at the point where one view switches to the next, the left and right eye see different views and the image is confusing. Also, it is inconvenient for the person who wants to see a previous view because they are forced to walk back and forth to the correct viewing angle. If these problems were solved, the underlying image would appear to the viewer as one continuous band, rather than the viewer experiencing multiple, broken, or banded images.

Currently there is a need for a display device that is capable of sequentially displaying lenticular images that would provide sufficient illumination for the images. In addition, it would be desirable to have a display device that has the capability of displaying clear pictures of the lenticular images without blurring.

### SUMMARY OF THE INVENTION

The present invention may be embodied as a lenticular image display device [10] for displaying lenticular picture [60] having a plurality of lenticular images [55, 65, 75] when tilted through an optimum predetermined tilt arc ‘a’ and an optimum rocking frequency ‘f’ comprising:

a receiver [20] for holding a lenticular picture [60] securely;
a base surface [31], designed to rock through a tilt arc about a single axis which approximately substantially matches said optimum tilt arc of said lenticular picture [60], the base surface [31] designed to limit rocking in other dimensions; and
a weighting system [90] having a weight [91] of a predetermined mass and location to allow rocking of the display device [10] at a rocking frequency ‘f2’ which substantially matches said optimum rocking frequency ‘f’ of the display device [10].

The foregoing enumeration of embodiments has been for illustrative purposes only. Other features and advantages of the present invention will become apparent from the following more detailed description, taken in conjunction with the accompanying drawings, which illustrate, by way of example, the principles of the invention.

### OBJECTS OF THE INVENTION

It is an object of the present invention to provide a display device, which holds a lenticular image that rocks on a curved base to allow images to be seen clearly.

It is an object of the present invention to provide a display device which holds and rocks a lenticular picture at an optimum rocking frequency.

It is another object of the present invention to provide a display device which rocks a lenticular picture around a single rotational axis.

### BRIEF DESCRIPTION OF THE DRAWINGS

A complete understanding of the present invention may be obtained by reference to the accompanying drawings, when considered in conjunction with the subsequent detailed description, in which:

FIG. 1 is a perspective view of a lenticular image display device according to one embodiment of the present invention.

FIG. 2 is a front elevational view of the lenticular image display device of FIG. 1. holding a lenticular picture on a base positioned at an optimum viewing angle to view a first image.

FIG. 3 is a front elevational view of the lenticular image display device of FIG. 1. holding a lenticular picture on a base positioned at an optimum viewing angle to view a second image.

FIG. 4 is a front elevational view of the lenticular image display device of FIG. 1. holding a lenticular picture on a base positioned at an optimum viewing angle to view a third image.

FIG. 5 is a view of the lenticular image showing an image and a secondary ghost image illustrating problems of the prior art.

FIG. 6 is a side view of a lenticular image display device with an adjustable weight according to an alternate embodiment of the present invention.

### DETAILED DESCRIPTION OF THE PRESENT INVENTION

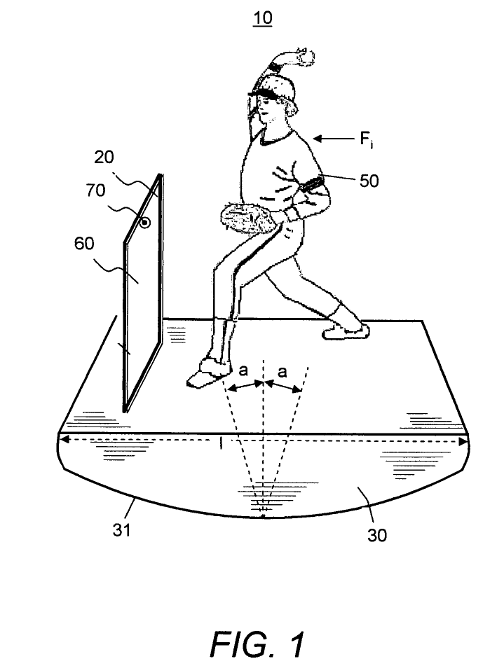

FIG. 1 shows a lenticular image display device 10 according to one embodiment of the present invention. The lenticular image display device 10 includes a receiver 20 for holding a lenticular picture 60 on a base 30. Receiver 20 may be simply a slot, or a frame which holds lenticular picture 60. Lenticular picture 60 shows several different images to a viewer as the line of sight (LOS) angle away from a perpendicular, the lenticular picture 60 changes.

Lenticular picture 60 is embedded with several lenticular images that are viewed in a sequence which give the illusion of motion or depth when the viewing angle changes.

The lenticular image 60 is designed to have an optimum viewing angle for each of its internal images. Some may be designed to have different images when the LOS angles from side to side off perpendicular when viewing the image. Others may provide different images as the LOS angles off perpendicular in an upward or downward angle. Therefore, a display device must tilt the picture in the manner it was designed for optimum performance.

The base 30 has a curved surface allowing it to rock when pushed with an initial force Fᵢ. The curved surface 31 completes an arc of a circle which approximates the optimum arc through which the lenticular picture 60 is intended to be viewed. The radius of curvature of the curved surface 31 is defined by this arc and the length “l”.

Surface 31, in this embodiment is allowed to rock (rotate) about a single axis of rotation, being forward and backward, but not side-to-side.

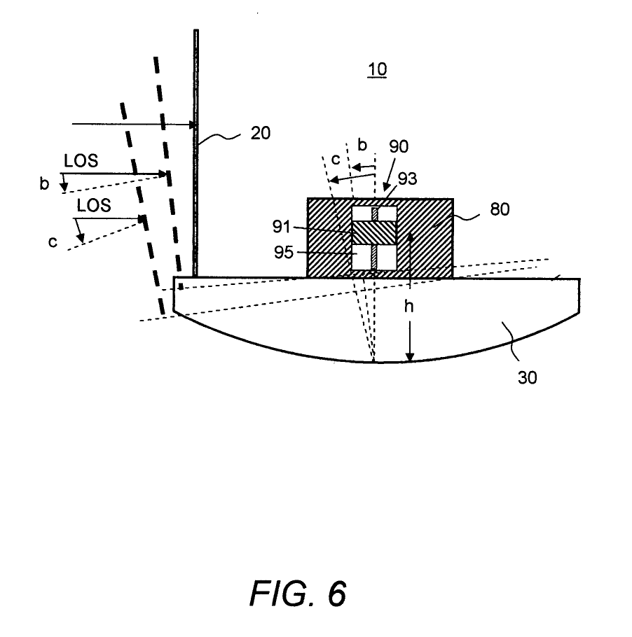

The frequency in which the display device 10 rocks is determined by the same principals which govern the swinging of a pendulum. The weight of the pendulum and the location of the center of gravity of the pendulum determine its natural swinging frequency. Therefore, it will be necessary to adjust the weight distribution of the display device to alter the natural rocking frequency to approximate an acceptable frequency of rotation of the lenticular picture 60. The adjustment of the distribution of weight is more fully described below in connection with the description of FIG. 6.

The lenticular picture 60 can include several images. The lenticular image(s) can include, but are not limited to, any custom image, such as a logo, message, printed image of a sports player such as a baseball player, graphics, typeface, logos, animation, video, computer-generated or digital art, vignettes, tints, dimensional art, graphs, charts, vector art and similar information.

The receiver 20 may also include at least one fastening device 70 to secure the lenticular picture 60 to the base 30. The fastening device 70 can be reusable or non-reusable. Examples of a temporary fastening device can include, for example, snaps, clips or hooks, buckles, Velcro for ease of fastening and reusability. An example of a permanent fastening device can include glue or tamperproof snap lock closures, resulting in a single fastenable use of the display device 10.

A typical length of the base 30 is 10 cm and the width is 6 cm. These dimensions are described for purposes of clarity and specificity; however, they should not be interpreted in any limiting way. Other dimensions are possible. However, it will be apparent to those of skill in the art that the dimensions and interlaced image resolutions can be oriented or arranged to correspond to directions as desired without departing from the scope of the invention.

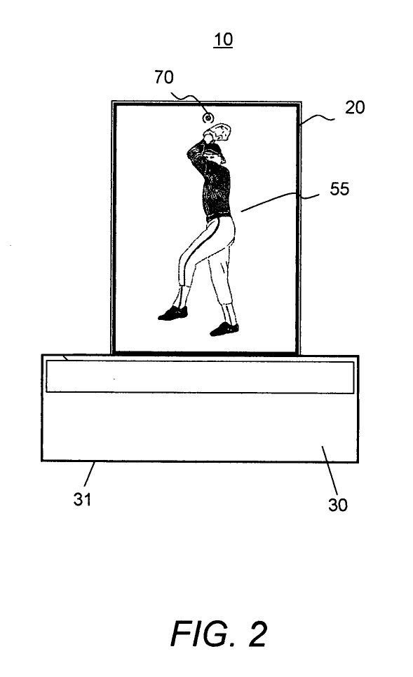

FIG. 2 is a front elevational view of the lenticular image display device 10 of FIG. 1 holding a lenticular picture 60 on a base 30 positioned at an optimum viewing angle offset to view a first image. FIG. 6 shows the position of the display device and the LOS angle to produce the image seen in FIG. 2. Here the display device 10 is in its resting position and the LOS is perpendicular to the image (no offset angle). Lenticular picture 60 was designed to show the first image 55 with an optimum viewing angle that is a perpendicular LOS.

The images of lenticular picture 60 and/or displays on display device 10 may include information that business entities want to promote, such as food and beverages, sports player likeness, goods and services, activities, new product launches or new amusements.

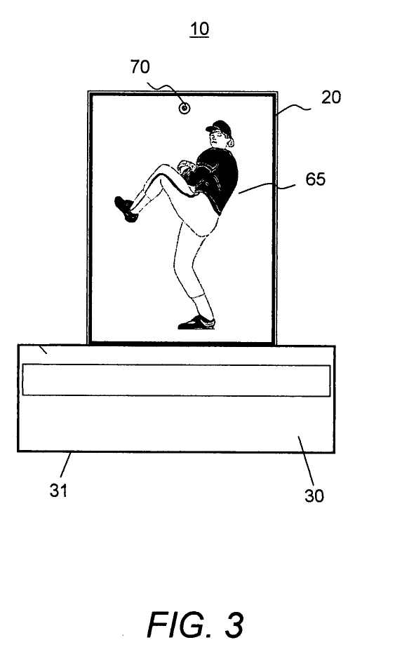

FIG. 3 is a front elevational view of the lenticular image display device 10 of FIG. 1 holding a lenticular picture 60 on a base 30 positioned at an optimum viewing angle offset to view a second image 65.

The base 30 is at an angle “c” which creates a LOS angle “c” offset from a perpendicular relative to lenticular picture 60 as shown in FIG. 6. Lenticular picture 60 was designed to show the second image 65 most clearly when viewed from the optimum offset angle “b”. The base 30 is allowed to rock in one dimension and is designed to limit rocking in other dimensions.

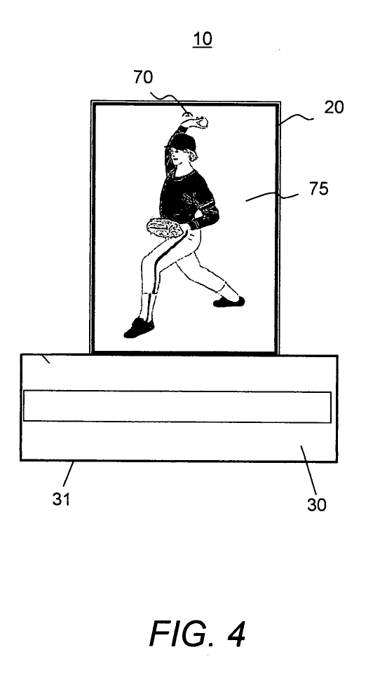

FIG. 4 is a front elevational view of the lenticular image display device 10 of FIG. 1 holding a lenticular picture 60 on base 30 positioned at an optimum viewing angle to view a third image 75.

Third lenticular image 75 can also be seen without blurring upon rocking (rotation or pivoting) the curved base 30 about a single rotational axis to an angle “c” which creates the same offset angle “c” for the LOS relative to the lenticular picture 60 as shown in FIG. 6. Again, the lenticular picture 60 was designed to provide the third image 75 when viewed from an offset angle “c”.

The rocking effect can be used to show two or more different images simply by changing the LOS viewing offset angle. FIGS. 2-4, when shown in sequence, illustrate the display with three lenticular images 55, 65 and 75 which give the illusion of motion illustrating a pitcher throwing a baseball. Lenticular image display device 10 of the present invention need not be limited to just three integral motion images. For example, several images could be incorporated into lenticular picture 60.

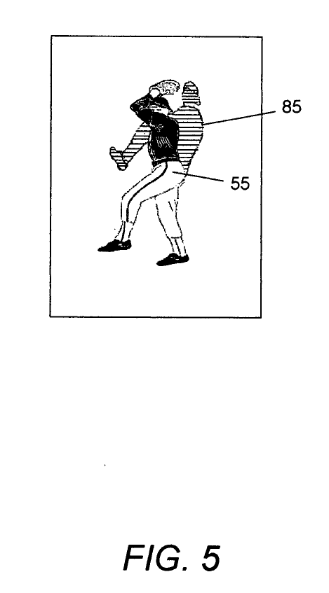

FIG. 5 is a perspective view illustrating the problems associated with prior art lenticular image displays. If a lenticular picture 60 is viewed at an incorrect angle in one or more planes, a partial image 55 may appear simultaneously with a ghost image 85.

The transition between the lenticular images 55, 65 and 75 can be improved by adding additional source images and rocking the base 30 about one axis of rotation which matches the optimum tilt arc. For example, a motion sequence can be produced by interlacing three or more sequential lenticular images of a batter in motion. A motion sequence is a sequence of images (such as two, three, four or more images) each image of which has at least one scene element in common but which changes location, shape or size within the scene in a logical manner through the sequence.

When a Lenticular image is tilted to provide a different viewing angle, other images are visible. If one tilts the lenticular picture too quickly, the images are blurred and not clear. The exact reason for the blurring is not known, however, when tilted slowly, images become visible and disappear until the next image appears. Therefore, if one tilts the Lenticular picture too slowly, there are periods of time in which there is no image shown. Also, if tilted too slowly, the fluid movement of a sequence of images is lost and does not approximate motion.

Therefore, there is an optimum tilting, or rotation frequency ‘f’ of the Lenticular picture 60 which presents the images in the clearest form with the most fluid impression of motion. This is considered the optimum rotation frequency of the lenticular picture.

FIG. 6 is a side view of a lenticular image display device 10 with an adjustable weighting system 90 according to an alternate embodiment of the present invention.

Display device 10 may employ a number of different structures 80 which may be a statue of an action figurine such as a baseball player 50 as shown in FIG. 1, football player, tennis player, basketball player or the like, a clock, and preferably includes a message so as to provide added value to the display device 10.

A weighting system 90 positioned on base 30 to adjust the frequency of rocking of the display device 10 at the rocking frequency ‘f2’ which substantially matches the optimum rocking frequency ‘f’ of the lenticular picture 60. In a preferred embodiment, the optimum weighting is determined for structure 80 and it is determined what the mass of the weight(s) [91] are required to be added, and where they are required to be added to provide the optimum rocking frequency. The weights 91 are then inserted inconspicuously into structure 80. The weighting system 90 moves the center of gravity to a different vertical location, which adjusts the rocking frequency of the display device 10. Preferably, weighting adjustments are performed during manufacturing process.

In an optional embodiment, the weighting system 90 may comprise a structure 80 having an adjustable weighting system 90. Adjustable weighting system 90 includes a receptacle 95 having a weight 91. The weight 91 is secured and adjustable and has a mechanism 93, which makes it movable in a vertical direction “h” inside of structure 80.

As illustrated in FIGS. 2-4, altering the angle by rocking the base 30 in one dimension which substantially matches the optimum tilt arc of the lenticular image(s) allows observer to see all the images. The resulting lenticular image may be referred to as a three-dimensional lenticular image. If at least three different perspective images are used, this can provide the ability to at least partially look around an object in the scene.

Typical applications of the present invention contemplate but are not limited to product manufacturing, installation, and maintenance. The foregoing enumeration of embodiments has been for illustrative purposes only. Other embodiments, combinations of embodiments and combinations of features are also within the scope and spirit of the teachings described herein, as will be apparent to persons skilled in the art of these teachings. While a particular form of the invention has been illustrated and described, it will be apparent that various modifications can be made without departing from the spirit and scope of the invention. Accordingly, it is not intended that the invention be limited, except as by the appended claims.

What is claimed is:

1. A lenticular image display device [10] for displaying lenticular picture [60] having a plurality of lenticular images [55, 65, 75] when tilted through an optimum predetermined tilt arc ‘a’ and an optimum rocking frequency ‘f’ comprising:
a) a receiver [20] for holding a lenticular picture [60] securely;
b) a base surface [31], designed to rock through a tilt arc about a single axis which approximately substantially matches said optimum tilt arc of said lenticular picture [60], the base surface [31] designed to limit rocking in other dimensions; and
c) a weighting system [90] having a weight [91] of a predetermined mass and location to allow rocking of the display device [10] at a rocking frequency ‘f2’ which substantially matches said optimum rocking frequency f of the display device [10].

2. The lenticular image display device [10] of claim 1 wherein the weighting system comprises:
a weight [91] of a predetermined mass inserted into the display device [10] at a predetermined height ‘h’ to adjust the center of gravity of the display device [10] such that it will rock at a frequency T which substantially matches said optimum rotation frequency for viewing the lenticular picture [60].

3. The lenticular image display device [10] of claim 1 wherein the weighting system comprises:
a) a receptacle [95] in the display device [10];
b) a weight [91] within the receptacle [95];
c) an adjustment mechanism [93] connected to weight [91] capable of positioning weight [91] vertically within the receptacle [91] to adjust a center of gravity of the display device [10] which corresponds to a rocking frequency ‘f’ which substantially matches said optimum frequency for viewing the lenticular picture [60].

4. The lenticular image display device [10] of claim 1 wherein the base further comprises: a structure [80].

5. The lenticular image display device [10] of claim 4 wherein the structure [80] is a sports figurine.

6. The lenticular image display device [10] of claim 4 wherein the structure [80] is a statue of a sports figure.

7. The lenticular image display device [10] of claim 1 wherein the structure [80] base further comprises:
personalized engraved messages.

8. The lenticular image display device [10] of claim 1 further comprising:
a receiver 20 for holding the lenticular picture [60].

9. A method of clearly displaying lenticular images comprising the steps of:
a) providing a lenticular picture [60] which provides at least two images [55, 65, 75] when viewed from at least two different viewing angles [‘b’, ‘c’];
b) providing a base [30] having a curved surface [31] shaped to rock about a single rotation axis through an arc [‘a’] substantially covering the at least two different viewing angles [‘b’, ‘c’],
c) attaching the lenticular picture [60] to the base [30],
d) providing an initial horizontal force Fᵢ to cause the display device [10] to begin rocking through the at least two different angles [‘b’, ‘c’] showing the at least two different images [55, 65, 75].

10. The method of claim 9, further comprising the step of:
adjusting a weight distribution of the display device [10] so as to cause the display device [10] to rock at a frequency f which substantially optimizes viewing of the at least two images [55, 65, 75].

11. The method of claim 10 wherein the step of adjusting the weight distribution comprises the steps of:
a) determining a weight [91] and location [‘h’] such that when the weight [91] is attached to the display device [10] at the determined location [‘h’] causes the display device [10] to rock at a frequency ‘f’ which substantially optimizes viewing of the at least two images [55, 65, 75]; and
b) attaching the determined weight [91] to the display device [10] at the determined location [‘h’] on the display device [10].

12. The method of claim 10 wherein the step of adjusting the weight distribution comprises the steps of:
a) providing a weight [91] with an adjustment device [93] on the display device [10];
b) adjusting the height [h′] of the weight [91] on the display device [10] to cause it to rock at a frequency ‘f’ which substantially optimizes viewing of the at least two images [55, 65, 75].
